(19) United States
(12) Patent Application Publication
(10) Pub. No.: US 2025/0086007 A1
(43) Pub. Date: Mar. 13, 2025

(54) SCHEDULING KERNELS ON A DATA PROCESSING SYSTEM WITH ONE OR MORE COMPUTE CIRCUITS

(71) Applicant: Xilinx, Inc., San Jose, CA (US)

(72) Inventors: Sumit Nagpal, Hyderabad (IN); Abid Karumannil, Malappuram (IN)

(73) Assignee: Xilinx, Inc., San Jose, CA (US)

(21) Appl. No.: 18/464,829

(22) Filed: Sep. 11, 2023

(51) Int. Cl. G06F 9/48; G06F 9/50

(52) U.S. Cl. CPC G06F 9/4881; G06F 9/5027

(57) ABSTRACT

Scheduling kernels on a system with heterogeneous compute circuits includes receiving, by a hardware processor, a plurality of kernels and a graph including a plurality of nodes corresponding to the plurality of kernels. The graph defines a control flow and a data flow for the plurality of kernels. The kernels are implemented within different ones of a plurality of compute circuits coupled to the hardware processor. A set of buffers for performing a job for the graph are allocated based, at least in part, on the data flow specified by the graph. Different ones of the kernels as implemented in the compute circuits are invoked based on the control flow defined by the graph.

### RESERVATION OF RIGHTS IN COPYRIGHTED MATERIAL

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

This disclosure relates to scheduling the processing of tasks on a data processing system with one or more compute circuits.

### BACKGROUND

Deep learning is a class of machine learning algorithms that use multiple layers of nonlinear processing units for feature extraction and transformation. Deep learning algorithms can be unsupervised (e.g., pattern analysis) or supervised (e.g., classification). The deep learning algorithm can be implemented using layers of an artificial neural network (ANN) (referred to herein as a “neural network”).

In general, a neural network is a collection of nodes, also referred to as “neurons,” that are connected in a graph. A node in a neural network computes a sum of weighted inputs and adds an optional bias to the sum. The output of the node is a function of the final sum (referred to as an “activation function”). Example activation functions include the sigmoid function, the hyperbolic tangent (tanh) function, the Rectified Linear Unit (ReLU) function, and the identity function. Neural network models are often organized into layers of nodes, which define a specific topology, and corresponding weights and biases. The weights and biases are referred to as network parameters.

A neural network application involves, in addition to the inference stage, compute-intensive stages such as pre-processing and post-processing of data. Pre-processing can include reading data from retentive storage, decoding, resizing, color space conversion, scaling, cropping, etc. Post-processing operations can include non-maximum suppression, SoftMax, and reformatting, for example,

A neural network can be defined as a directed acyclic graph in which the nodes represent the functions performed in processing an input data set. Machine learning platforms such as Caffe and TensorFlow provide frameworks for defining and running graphs of neural networks. The different functions can be performed on different compute circuits (or “kernels”) in order to improve throughput. For example, field programmable gate arrays (FPGAs) have been used to implement circuits that accelerate functions called from software in neural network applications.

### SUMMARY

In one or more example implementations, a method includes receiving, by a hardware processor, a plurality of kernels and a graph including a plurality of nodes corresponding to the plurality of kernels. The graph defines a control flow and a data flow for the plurality of kernels. The method includes implementing, by the hardware processor, the plurality of kernels within different ones of a plurality of compute circuits coupled to the hardware processor. The method includes allocating a set of buffers for performing a job for the graph. The set of buffers is allocated based, at least in part, on the data flow specified by the graph. The method includes invoking, by the hardware processor, different ones of the plurality of kernels as implemented in the plurality of compute circuits based on the control flow defined by the graph.

The foregoing and other implementations can each optionally include one or more of the following features, alone or in combination. Some example implementations include all the following features in combination.

In some aspects, the plurality of compute circuits are heterogeneous.

In some aspects, the different ones of the plurality of kernels share data during execution via the set of buffers as allocated.

In some aspects, the graph specifies the data flow by defining one or more input buffers and one or more output buffers for each kernel.

In some aspects, the graph specifies the control flow by, for each kernel, specifying a next node to be executed, a plurality of next nodes to be executed in parallel, or that no further node is executed.

In some aspects, the plurality of kernels are specified in a file of high-level programming language source code that includes buffer metadata defining requirements of each buffer. The set of buffers can be determined based on the requirements of each buffer determined by the hardware processor by querying the file including the buffer metadata.

In some aspects, the allocating includes, at runtime, generating a graph buffer pool that creates the set of buffers for performing the job for the graph. The method includes maintaining a buffer pool stack for the graph. The buffer pool stack is configured to store graph buffer pools for the graph while not in use.

In some aspects, the method includes, in response to a new job being queued for the graph and no graph buffer pool being available in the buffer pool stack for the graph, creating a new graph buffer pool for the new job for the graph.

In some aspects, the method includes, at runtime, executing graph generation program code that is executable to generate the graph at runtime.

In some aspects, the graph includes logic that, upon execution, selects one of a plurality of conditional branches within the graph based on a value returned by a selected kernel of the plurality of kernels.

In some aspects, the method includes, in response to at least two kernels executing in different compute circuits of the plurality of compute circuits disposed in a same device, sharing a single buffer among the at least two kernels.

In some aspects, the invoking different ones of the plurality of kernels includes writing, by a first kernel, to a device buffer as allocated, passing, by the first kernel, a handle to the device buffer to a second kernel, and accessing, by the second kernel, the device buffer.

In one or more example implementations, a system includes one or more hardware processors configured (e.g., programmed) to execute operations as described within this disclosure.

In one or more example implementations, a computer program product includes one or more computer readable storage mediums having program instructions embodied therewith. The program instructions are executable by computer hardware, e.g., a hardware processor, to cause the computer hardware to initiate and/or execute operations as described within this disclosure.

This Summary section is provided merely to introduce certain concepts and not to identify any key or essential features of the claimed subject matter. Other features of the inventive arrangements will be apparent from the accompanying drawings and from the following detailed description.

### BRIEF DESCRIPTION OF THE DRAWINGS

The inventive arrangements are illustrated by way of example in the accompanying drawings. The drawings, however, should not be construed to be limiting of the inventive arrangements to only the particular implementations shown. Various aspects and advantages will become apparent upon review of the following detailed description and upon reference to the drawings.

FIG. 1 illustrates an example system for processing one or more machine learning (ML) applications in accordance with the inventive arrangements described within this disclosure.

FIG. 2 illustrates an example flow diagram of an ML application and a system manager.

FIG. 3 is a visual representation of the graph of Example 6.

FIG. 4 is a visual representation of the graph of Examples 10 and 11.

FIG. 5 is a method illustrating certain operative features of the system described in connection with FIGS. 1 and 2 as implemented by a computing environment including a data processing system and a plurality of compute circuits.

FIG. 6 is another method illustrating certain operative features of the system described in connection with FIGS. 1 and 2 as implemented by a computing environment including a data processing system and a plurality of compute circuits.

FIG. 7 illustrates an example implementation of a system that includes a plurality of compute circuits.

FIG. 8 is a block diagram depicting an example of an accelerator integrated circuit of the system of FIG. 7.

### DETAILED DESCRIPTION

While the disclosure concludes with claims defining novel features, it is believed that the various features described within this disclosure will be better understood from a consideration of the description in conjunction with the drawings. The process(es), machine(s), manufacture(s) and any variations thereof described herein are provided for purposes of illustration. Specific structural and functional details described within this disclosure are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

According to the disclosed approaches, a framework is provided to prepare a machine learning (ML) application and then execute the ML application on a system that includes heterogeneous compute circuits. The framework supports the creation of a graphical representation of tasks of the ML application and the scheduling tasks of the ML application to improve processing throughput. The framework provides parallel deployment of workloads, achieves high utilization of the compute circuits, and enables convenient identification of bottlenecks in the system.

A kernel is a specific configuration of hardware or hardware executing software that performs a designated task of the ML application. Examples of kernels defined according to the approaches described herein are shown in Table 1.

TABLE 1

| Kernel Name | Description |
|---|---|
| DPUCADX8GRunner | Runs inference on DPUCADX8G (DPUv1 Alveo |
| | U-200/U-250) |
| CaffeKernel | Executes a network using Caffe framework |
| ImageRead | Reads an image with provided path |
| ClassificationAccuracy | Measures accuracy of a classification network |
| | (Top-1/Top-5) |
| ClassificationFCSoftMaxTopK | Performs FC + Softmax + TopK for a |
| | classification network |
| Classification ImreadPreProcess | Reads an image and preprocesses it for |
| | classification network |
| ClassificationPreProcess | Preprocesses an image for a classification |
| | network |
| Classification PostProcess | Performs Softmax + TopK for a classification |
| | network |
| Detection ImreadPreProcess | Reads and Preprocesses an image for YOLO |
| | network |
| Detection PreProcess | Preprocesses an image for YOLO network |
| PythonKernel | Executes kernels written in Python |
| SaveBoxesDarknetFormat | Saves results of detection network in Darknet |
| | format for mAP calc |
| YoloPostProcess | Postprocesses data for YOLO v2/v3 network |
| ClassificationPreProcessAccel | Performs FPGA accelerated pre-processing for |
| | classification network |

The processing of a kernel is specified by a “kernel object.” A kernel object is an instance of a kernel. At runtime, for example, the framework creates a kernel object from a definition of a kernel as described herein in greater detail below. For example, a kernel object having the same name as kernel, DPUCADX8GRunner, specifies inference processing on an FPGA (an Alveo U-200/U-250), and a kernel object having the same name as kernel, CaffeKernel, executes a network on a CPU using a Caffe framework on a CPU.

The processing of kernels is performed by compute circuits. In some aspects, the compute circuits are heterogeneous. In other aspects, the compute circuits are not heterogeneous, but rather are homogeneous. The “kernel type” of a kernel identifies a compute circuit on which the processing of the kernel is performed. The processing of a kernel can be performed on different compute circuits, in which case the kernel type is the combination of the different types of compute circuits. Kernel types can include CPU, GPU, VPU, DSP, RISC processor, FPGA, ASIC, SoC or combinations thereof, for example.

The work or job to be performed by an ML application can be specified as a directed acyclic graph and represented by nodes and edges in a computer system memory. Each node represents a task to be performed and specifies an assignment of the task to one or more kernels. In accordance with the inventive arrangements described within this disclosure, the graphs specify both a control flow and a data flow. Thus, certain edges represent data dependencies between nodes, while other edges represent control flow. In this regard, the control flow and the data flow may be specified independently of one another within the graphs. Examples of tasks include inputting data, formatting input data, computing operations associated with layers of a neural network, and those in the description of the kernels in Table 1.

The disclosed methods and systems enable assignment of a task to multiple kernels, where the kernel may be of different kernel types. For example, a task can be assigned to both a kernel of kernel type CPU and a kernel of kernel type FPGA. The task is eligible to be performed by either of the kernels.

Task queues are created in the memory for enqueuing tasks represented by nodes of the graph(s). In one or more examples, each kernel is associated with one and only one task queue. More than one kernel can be associated with one (the same) task queue. A task queue can be assigned to queue tasks represented by one or more nodes of one or more graphs. A single task queue is created to queue tasks associated with multiple nodes if at least one same kernel is in the sets of kernels assigned to the multiple nodes. For example, if node N1 has assigned kernels K1 and K2, and node N2 has assigned kernels K2 and K3, then the tasks represented by nodes N1 and N2 are queued to the same task queue. The threads of K1 are limited to dequeuing tasks represented by N1, the threads of K2 can dequeue tasks represented by either N1 or N2, and the threads of K3 are limited to dequeuing to tasks represented by N2.

The kernel objects are associated with threads that enqueue and dequeue tasks in and from the task queues. A thread enqueues a task, which is represented by a node in the graph, in a task queue in response to completion of the task(s) of the parent node(s) of that node. The task queue in which a task is enqueued by a thread is the task queue that is associated with the node that represents the task.

A thread associated with a kernel object dequeues a task from the task queue to which that kernel object is assigned. The thread executing on the kernel object activates a compute circuit that is associated with the kernel object to initiate processing of the dequeued task. For example, for a kernel object of a CPU kernel type, the thread can initiate program code on the CPU and associated with that kernel object for performing the designated task on the data specified by task parameters. For an FPGA kernel type, the kernel object can be provided to the FPGA addresses in an external memory of data to be processed along with control information.

Accordingly, the kernels of the graph(s) are scheduled to operate on different ones of the compute circuits of the system. For each graph, the control flow specified by the graph defines an order of execution among the various linked kernels of the graph as scheduled to the various compute circuits of the system. For each graph, the data flow specified by the graph defines what data is passed from one kernel to another. For example, the data flow may define the input buffer(s) and/or output buffer(s) of each kernel of the graph(s).

Further aspects of the inventive arrangements are described below with reference to the figures. For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

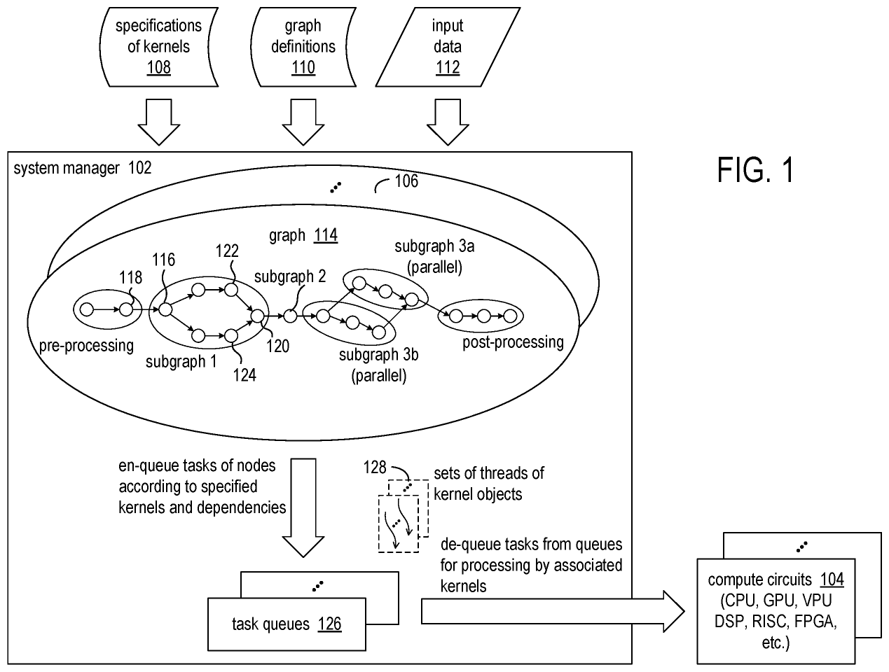

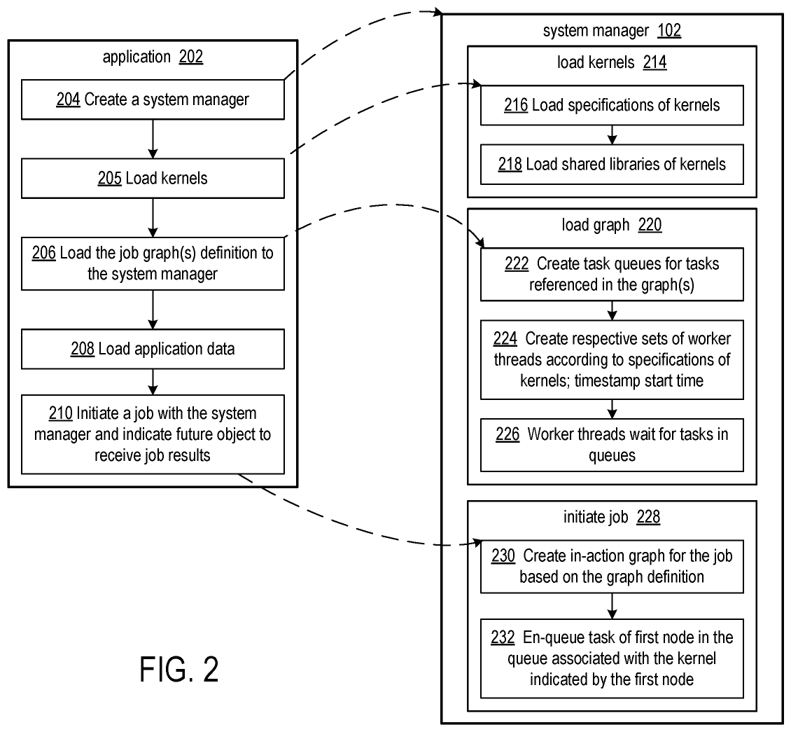

FIG. 1 shows a system for processing one or more ML applications according to the disclosed methods. The system generally includes a system manager 102 that is coupled to a collection of compute circuits 104. The compute circuits may be heterogeneous. The system manager 102 is implemented as a framework that is executed by a computer system. As executed, the system manager 102 is configured to direct the operations of compute circuits according to tasks defined by graphs 106. The system manager 102 inputs kernel specifications 108 and graph definitions 110 to instantiate kernel objects (not shown) and graphs 106. The input data 112 is input by a kernel object at application runtime, such as reading data from retentive storage or a networked source. The scheduling of tasks of the graph(s) to be performed by the compute circuit is explained in the description of FIG. 2. Additional information regarding scheduling of tasks of graphs can be found in U.S. Pat. No. 11,561,826 to Nagpal et al., which is incorporated herein by reference.

A system can be configured to include different compute circuits to execute different tasks of the ML application(s). As noted, the compute circuits may be homogeneous (e.g., of the same type) or heterogeneous (e.g., of different type). For example, a CPU can be programmed to perform a pre-processing task of a graph, and an FPGA can be configured to perform tasks of tensor operations as part of inference. Accessing the computational capabilities of the compute circuits is achieved through kernel objects, which are defined in the kernel specifications 108. In another example, a first CPU (FPGA) may perform the pre-processing task while a second CPU (FPGA) performs tasks of tensor operations as part of inference.

The properties of a kernel object can include name, purpose, device type, a path to a shared library that contains the functions to interface to and/or be performed by the compute circuit, a number of parallel threads that can execute functions of the kernel object, and a list of parameters used by the kernel object. For example, the kernel parameters specify the particular type of compute circuit on which a given kernel is intended to execute. In one or more examples, kernel specifications can be specified as JavaScript Object Notation (JSON) files, for example. In one or more examples, kernel objects can be synchronous (blocking) by default. A kernel object can alternatively be defined to operate asynchronously (non-blocking). Example 1 shows a JSON description of a kernel. In Example 1, the kernel is intended to execute on a “CPU” type of compute circuit based on the “device_type” parameter.

### Example 1

```
/* Copyright 2019 Xilinx Inc. */
{
  “kernel_name” : “ImageRead”,
  “description” : “Reads and image from the image_path provided”,
  “kernel)type” : “cpp”,
  “device_type” : “cpu”,
  “kernel_lib” : “libs/libImageRead.so”,
  “num_cu” : 8,
  “param_list” : {
    “image_path” : {“type” : “string”}
  }
}
```

The JSON specification shows that each kernel is associated with a shared library (the “.so” file), which is expected to have a “getKernel” function. The getKernel function returns a kernel object of a KernelBase class. Example 2 is the KernelBase class.

### Example 2

```
/* Copyright 2019 Xilinx Inc .* /
  class KernelBase
  {
    public:
        virtual ~KernelBase ( ) { }
      /// Returns total number of CPU threads to be allocated
      /// for this kernel. If there are multiple nodes of same
      /// kernel, allocated threads are shared. Alternately, it
      /// can be specified in kernel JSON also. Default is −1.
      /// It means number provided in JSON is used. If it is
      /// not mentioned in JSON also, a single thread is used,
        virtual int getNumCUs( ) {return −1;}
        /// Returns whether kernel execution is an asynchronous
        /// operation.
virtual bool isExecAsync ( ) { return false; }
      /// Actual operation to be executed. It could be either
      /// blocking or non-blocking(async) call. If async, it
      /// is mandatory to implement wait( ) method also.
        /// @param in Input data to the kernel
        /// @param out Output data of the kernel
        /// @param params Node parameters. Unique to a
        /// particular node.
        /// @param dynParams Input parameters. It changes with
          /// each input.
          /// @return execID An ID unique to this operation.
          /// Used for waiting for its result in async call.
          virtual int exec_async (
              std::vector<AKS::DataDescriptor *> &in,
              std::vector<AKS::DataDescriptor *> &out,
              NodeParams* params,
              DynamicParamValues* dynParams) = 0;
            /// Wait operation for asynchronous kernel execution
          /// Required only if isExecAsync( ) is true.
          /// @param execID An ID returned by exec_async call
            /// in async call.
          // @params Node parameters. Unique to a particular
          /// node.
          virtual void wait (int, NodeParams*) { }
          /// Initialize a Node
          /// The system manager (or Al Kernel Scheduler,
            /// “AKS”) performs this operation for each node in
            /// a graph as soon as graph is loaded. Any setup
          /// operations wrt a node could be implemented here
          /// @param params Node parameters. Unique to a
          /// particular node.
          virtual void nodelnit(NodeParams*) { }
          /// Report any info by each node
          /// If any kernel wants to print any info after all jobs,
          /// it could be added here. Eg: Accuracy kernel wants
          /// to report final accuracy over a full dataset. It is
          /// invoked for every node by SysManagerExt::report( )
          virtual void report(AKS :: NodeParams* nodeParams) { }
  };
}
```

A property of the example KernelBase class is that an inherited kernel class must implement an “exec_async” function, which is called by the system manager 102 to run the kernel. By default, all kernels are blocking. For non-blocking kernels, the function will return a job_id of the kernel. If a kernel is non-blocking, the “isExecAsync” function should be implemented to return the Boolean value “true.” A non-blocking kernel must implement a “wait” function. The wait function is called by a thread dedicated to waiting for the results of the associated task.

A kernel uses the getNumCUs function to determine the number of threads executing the kernel object, which is configurable in the JSON description of the kernel. The “nodeInit” function initializes the kernel object with node-specific data. For example, an inference kernel object may need to load different networks that are used in different graphs. Thus, for each node that specifies an assignment of the task to a kernel, the kernel object makes separate calls to nodeInit with the parameter values specified by the node.

An example of a kernel is shown in Example 3. The AddKernelBase defines a “getKernel” function, which returns an object of the class “AddKernel” inherited from KernelBase. The AddKernel class implements the “exec_async” function.

### Example 3

```
/* Copyright 2019 Xilinx Inc.*/
class AddKernelBase: public AKS::KernelBase {
  public:
    int exec_ async (
      std::vector<AKS::DataDescriptor *> &in,
      std::vector<AKS::DataDescriptor *> &out,
      AKS::NodeParams* params,
      AKS::DynamicParamValues* dynParams);
    int getNumCUs(void);
};
extern “C” {
AKS::KernelBase* getKernel (AKS::NodeParams* params) {
  AddKernelBase* base = new AddKernelBase( );
  return base;
}
} // extern C
int AddKernelBase::getNumCUs(void)
{
  return 1;
}
int AddKernelBase::exec_async (
  vector<AKS::DataDescriptor *>& in,
  vector<AKS::DataDescriptor *>& out,
  AKS::NodeParams* params,
    AKS::DynamicParamValues* dynParams)
{
    AddKernelBase* kbase = this;
    float* input = (float*)(in[0]−>data( ));
  // Create one output buffer and resize buffer to required size
    out.push_back(new AKS::DataDescriptor({1},
          AKS::DataType::FLOAT32));
    float* output = (float*)(out[0]−>data( ));
    output[0] = input[0] + params−>_intParams[“adder”];
    std::cout << “Node Output : “ << params << “ “ << input[0]
        << “ “ << output[0] << std::end1;
    return −1;
}
```

In one or more other examples, a tensor buffer class may be used. For purposes of illustration, referring to Example 1 above, the following lines of code:

```
virtual int exec_async (
      std::vector<AKS::DataDescriptor *> &in,
      std::vector<AKS::DataDescriptor *> &out,
      NodeParams* params,
      DynamicParam Values* dynParams) = 0;
```

may be replaced with the lines of code below:

```
int AddKernel::exec_async(std::vector<vart::TensorBuffer*>& in,
            std::vector<vart::TensorBuffer*>& out,
      AKS::NodeParams* params,
      AKS::DynamicParamValues* dynParams) {
```

The line “int AddKernel::exec_async(std::vector<vart::TensorBuffer*>& in” and lines of code that follow use a tensor buffer class. The tensor buffer class allows the buffer to be a device buffer. This means that data to be passed from one kernel and/or device to another may do so without having to first be stored in a host buffer. This capability facilitates more efficient and faster data transfers from one kernel and/or compute circuit to another by avoiding the round-trip journey of data from device to host prior to being provided to another device.

For purposes of illustration, another example of a kernel is shown in Example 3.1 below in which the tensor buffer class illustrated above is used.

### Example 3.1

```
/* Copyright 2023 Xilinx Inc.*/
class AddKernelBase: public AKS::KernelBase {
  public:
  int exec_async (
    std::vector<vart::TensorBuffer *> &in,
    std::vector<vart::TensorBuffer *> &out,
    AKS::NodeParams* params,
    AKS::DynamicParamValues* dynParams);
  int getNumCUs(void);
};
int AddKernelBase::exec_async (
  vector<vart::TensorBuffer *>& in,
    vector<vart::TensorBuffer *>& out,
  AKS::NodeParams* params,
    AKS::DynamicParamValues* dynParams)
{
  AddKernelBase* kbase = this;
  float* input = reinterpret_cast<float*>(in[0]−>data( ).first);
  // Create one output buffer and resize buffer to required size
  std::string tensorName (“add-out”);
  out.push_back(new AKS::AksTensorBuffer(xir::
  Tensor::clone(in[0]−>get_tensor( ))));
  float* output = reinterpret_cast<float*>(out[0]−>data( ).first);
  // Add
  output[0] = input[0] + params−>_intParams[“adder”];
  return 0;
}
```

The work to be performed by an ML application on an input data set can be divided into the tasks to be performed and each task can be represented as a node in a graph. For example, a classification application can have tasks for image read, image resize, image subtraction, inference, and SoftMax calculation. Some tasks can be divided into subtasks, and the subtasks represented as subgraphs. For example, separate tensor operations involved in inference can be nodes of a subgraph. Some tasks can be combined into a single task. For example, image read, image resize, and mean subtraction can be combined into a “pre-processing” task and represented by a single node. The task of a node is associated with one or more kernels. The graph definitions can be specified as JSON files, for example.

Each graph has a name and specifies a list of nodes. Examples of networks that can be used in different ML applications for which graphs can be defined include GoogleNet, ResNet50, YOLOv3-Tiny, YOLOv2, and Face Detect. The properties of each node include: a unique name, which kernel objects can process the task of the node, specifications of parameters for each associated kernel object, and a list of nodes (“child” nodes) to which the node connects defining a control flow. The child nodes of a parent node are dependent on completion of the task of the parent node. In accordance with the inventive arrangements described herein, each graph may also include buffers to be used for input and/or output of the various kernels thereby defining data flows independently of the control flow. Graph 114 is an example of a directed acyclic graph created by the system manager 102 in response to one of the graph definitions 110. The example graph 114 includes multiple subgraphs, which are labeled “pre-processing,” “subgraph 1,” “subgraph 2,” “subgraph 3 a,” “subgraph 3 b,” and “post-processing.” Each of the subgraphs is also a directed acyclic graph.

The graph illustrates the dependencies between nodes as directed edges that connect the nodes. For example, the task of node 116 of subgraph 1 is dependent on completion of the task of node 118 of the pre-processing subgraph. Note that the task of node 120 is dependent on completion of the tasks of nodes 122 and 124. A dependency of a child node on a parent node can be predicated on the task of the child node requiring data provided by the parent node.

The system manager 102 creates task queues 126 for queueing tasks associated with the nodes in the graphs 106. Each task queue is assigned to queue the tasks indicated by one or more nodes in the graphs 106. If two or more nodes of the same graph or two or more nodes of different graphs have at least one associated kernel that is the same, one task queue can be assigned to queue the tasks associated with those two or more nodes. Thus, the threads associated with different kernel objects can dequeue tasks from the same task queue.

The functions of each kernel object are executed by one or more threads. The number of threads started by each kernel object can be in response to a configuration parameter of the kernel object. Different kernel objects can be configured to execute different numbers of threads. Each set of the sets of threads 128 represents the one or more threads executed by a particular kernel object.

Each thread dequeues tasks from the task queue assigned to the kernel object the thread is executing. After dequeuing a task, the thread activates the compute circuit associated with the kernel object to initiate processing of the dequeued task.

Each thread can also enqueue tasks to the task queues 126. A thread can enqueue a task represented by a node in response to completion of each task of each parent node of that node. For example, the task represented by node 120 can be enqueued in a task queue once the tasks represented by nodes 122 and 124 have been completed. The task queue to which a task is enqueued is the task queue that is associated with the node that represents the task.

Tasks from different ones of the graphs 106 can be enqueued in the same one of the task queues 126. The graphs 106 can be defined for different ML applications, and the tasks represented by each graph are independent of data processed by the tasks represented by each other graph. A task from one of the graphs 106 and another task from another one of the graphs can be enqueued to the same task queue (by separate threads of separate kernel objects) if both of the nodes that represent those tasks specify assignments to at least one kernel that is the same.

FIG. 2 illustrates an example flow diagram of an ML application 202 and a system manager 102. The ML application 202 can invoke functions of a system library. The system library can include base classes on which a designer can build custom kernel objects and graphs as described herein. Example 4 shows an example of an application constructed according to the disclosed methods.

### Example 4

```
/* Copyright 2019 Xilinx Inc.*/
int main(int argc, char ** argv)
{
  int ret = 0;
...
  /// Get AKS System Manager instance
  AKS::SysManagerExt * sysMan =
AKS::SysManagerExt::getGlobal( );
  /// Load all kernels
  sysMan−>loadKernels(“kernel_zoo”);
  /// Load graph
  sysMan−>loadGraphs(graphJson) ;
  /// Get all the images in the given input directory,
  std::vector<std::string> images;
  int i = 0;
  for (boost::filesystem::directory_iterator it {imgDirPath};
      it != boost::filesystem::directory_iterator{ }; it++) {
    std::string fileExtension =
        it−>path ( ) .extension!) .string ( ) ;
    if(fileExtension == “.jpg” || fileExtension == “.JPEG”||
            fileExtension == “.png”)
      images.push_back((*it).path( ).string( ));
}
/// Get graph instance
AKS: AIGraph *graph − sysMan−>getGraph(“goglenet”);
/// Enqueue the images to graph for execution
for (auto& imagePath: images) {
  std::vector, AKS::DataDescriptor> v; v.reserve(3);
  sysMan−>enqueueJob (graph, imagePath, std::move(v),
        nullptr);
}
  /// Wait for results
  sysMan−>waitForAllResults( ) ;
  /// Report − applicable for accuracy kernel
  sysMan−>report(graph) ;
  AKS::SysManagerExt::deleteGlobal( );
  return ret;
}
```

In block 204, the application 202 (e.g., an ML application) can call a system library function to create a system manager 102. The system manager 102 provides initialization functions for loading kernels at block 214, loading graph(s) in block 220, and initiating a job in block 228 (tasks of a job being defined by a graph as explained above).

In block 205, the application 202 calls a system manager function to load kernels. The application specifies the kernel specification to be loaded. In block 216 the system manager 102 loads the referenced kernel specifications, and in block 218 the system manager 102 loads the shared libraries referenced by the kernel specifications. In loading the kernels, the system manager creates the kernel objects according to the kernel specifications.

In block 206, the application 202 calls a system manager function to load a graph(s). The application 202 specifies the graph(s) to be loaded. In block 222 the system manager 102 loads the referenced graph(s) and creates task queues for the tasks represented by nodes in the graph(s). The kernel objects are assigned to the tasks queues by way of kernels being referenced by the nodes that represent the tasks queued in the task queues. The system manager can also perform node initialization functions such as loading weights and biases.

In block 224, the system manager starts respective sets of worker threads for the kernel objects defined by the loaded kernel specifications. The number of threads started for a kernel object is that defined in the kernel specification. The worker threads store timestamps of the start times in system memory for purposes of accumulating performance information pertaining to the kernel objects. The worker threads then wait in block 226 for tasks to appear in the task queues.

In block 208, the application 202 loads data to be processed, such as from local retentive storage or a networked source, into memory that is accessible to the compute circuits. In block 210, the application instructs the system manager 102 to initiate processing a job using the loaded data.

To initiate processing a job in block 228, the system manager creates an in-action graph for the job based on the graph definition of the job in block 230. Each in-action graph is associated with a job and has dedicated data buffers and related objects for that job. As worker threads process tasks of different jobs, the threads do not need to communicate with one another because the threads are working on independent objects.

Each in-action graph is a lightweight representation in memory of an instance of a graph definition. The runtime data associated with processing a job until the job is complete is maintained in an in-action graph. For example, the in-action graph of a job can include a job identifier, the input data and output data of each node relevant to each node in the graph, the in-degree and out-degree of each node as the job is processed, application input parameters associated with the job, and reference to the full job graph definition. The in-action graph can have respective storage areas for output data generated by processing the tasks of the nodes. Once the tasks of an in-action graph are completed, the output is stored in a designated future object associated with the job, and the memory allocated to the in-action graph can be freed.

In block 232, the system manager enqueues the task represented by the first node of the graph in the task queue assigned to queue the task. A job can entail processing of multiple input datasets according to the tasks defined by a graph. For each new dataset input by the application 202 for processing of job, another in-action graph can be created for processing the new dataset. The system manager can continue to add tasks to the task queue associated with the first node of the in-action graph in response to a new dataset provided by the application. Once a job is complete, the application 202 can call on the system manager to store a timestamp indicating completion of the job.

The system manager 102 also supports loading of new kernels and loading of new graphs on-the-fly. That is, concurrent with threads executing kernel objects (enqueuing tasks, dequeuing tasks, and activating compute circuits) for performing tasks associated with an already-instantiated graph, the application 202 can call on the system manager to load new kernels, generate another graph, and start any new threads needed to execute any new kernels.

Example 5 illustrates an implementation of a kernel in accordance with one or more embodiments. In Example 5, the kernel includes both the program code defining the functionality of the kernel and any necessary parameters for the kernel. For purposes of illustration, the kernel illustrated in Example 5 combines the parameters and/or information previously provided as a JSON file (e.g., as shown in Example 1) with the kernel program code (e.g., as shown in Example 3) into a single file rather than splitting the parameters from the executable program code.

### Example 5

```
/* Copyright 2019 Xilinx Inc.*/
// Kernel Functions Implementation
#include <iostream>
#include <mutex>
#include <sstream>
#include <vector>
#include <aks/AksKernelBase.h>
#include <aks/AksLogger.h>
#include <aks/AksNodeParams.h>
#include <aks/AksTensorBuffer.h>
class AddKernel : public AKS::KernelBase {
public:
  AddKernel(AKS::NodeParams*) { }
  void nodeInit(AKS::NodeParams*, const std::vector<xir::Attrs*>& ) override;
  int exec_async(std::vector<vart::TensorBuffer*>& in,
          std::vector<vart::TensorBuffer*>& out, AKS::NodeParams* params,
          AKS::DynamicParamValues* dynParams) override;
  void report(AKS::NodeParams* nodeParams);
  static AKS::KernelInfo getKernelInfo( );
  std::vector<AKS::BufferMetaData>
  get_inputs_metadata(AKS::NodeParams* params = nullptr) override {
    std::vector<AKS::BufferMetaData> res;
    auto tensor = xir::Tensor::create(“in”, {1}, xir::create_data_type<int>( ));
    tensor−>set_attr(“buffer_type”,
            std::make_any<AKS::BufferType>(AKS:BufferType::CPU));
    res.push_back(std::move(tensor));
    return res;
  }
  std::vector<AKS::BufferMetaData>
  get_outputs_metadata(AKS::NodeParams* params = nullptr) override {
    std::vector<AKS::BufferMetaData> res;
    auto tensor = xir::Tensor::create(“out”, {1}, xir::create_data_type<int>( ));
    tensor−>set_attr(“buffer_type”,
            std::make_any<AKS::BufferType>(AKS::BufferType::CPU));
    res.push_back(std::move(tensor));
    return res;
  }
  // int getNumCUs(void);
private:
  std::mutex mtx;
  std::vector<std::string> data;
  int adder = 0;
};
// int ConditionalKernelBase::getNumCUs(void)
// {
// return 1;
// }
AKS::KernelInfo AddKernel::getKernelInfo( ) {
  return {
  /*.name = */ “AddKernel”,
  /*.description = */ “Adds constant value to input”,
  /*.kernel_type = */ “cpp”,
  /*.device_type = */ “cpu”,
  /*.num_cu = */ 1,
  /*.param_list = */ {
    {“adder”, {/*.type = * / “int”, /*.is_optional = */ false}}
  }
  };
}
void AddKernel::nodelnit(AKS::NodeParams* node_params, const
std::vector<xir::Attrs*>& /*attrs*/) {
  adder = node_params−>getValue<int>(“adder”);
}
int AddKernel::exec_async(std::vector<vart::TensorBuffer*>& in,
                std::vector<vart::TensorBuffer*>& out,
                AKS::NodeParams* params,
                AKS::DynamicParam Values* dynParams) {
AddKernel* kbase = this;
std::stringstream ss;
  // Create one output buffer and resize buffer to required size
  int* output = reinterpret_cast<int*>(out[0]−>data( ).first);
  // Add
  ss << “Add ” << adder << “ : [”;
  int res = 0;
  for (auto tin : in) {
    int* input = reinterpret_cast<int*>(tin−>data( ).first);
    res += input[0];
    ss << input[0] << “, ”;
  }
  res += adder;
  output[0] = res;
  ss << “] −> ” << output[0] << std::endl;
  {
    std::lock_guard<std::mutex> lk(mtx);
    data.push_back(ss.str( ));
  }
  return 0;
}
void AddKernel::report(AKS::NodeParams* nodeParams) {
  for (auto& str : data) {
    LOG_X(VL_INFO) << str << std::endl;
  }
}
REGISTER_KERNEL(AddKernel);
```

As noted, in one or more example implementations, graphs 106 may be adapted to explicitly specify both control flow and data flow. Example 6 illustrates a graph that explicitly specifies both control flow and data flow that may be executed by the system of FIG. 1.

### Example 6

| { | |
|---|---|
| “graph_name” : “adder3_json” | |
| “blob_list” : { | |
| { | |
| “blob_name” | : “X”, |
| “blob_shape” | : [1], |
| “data_type” | : “INT32” |
| }, | |
| { | |
| “blob_name” | : “A”, |
| “blob_shape” | : [1], |
| “data_type” | : “INT32” |
| }, | |
| { | |
| “blob_name” | : “B”, |
| “blob_shape” | : [1], |
| “data_type” | : “INT32” |
| }, | |
| { | |
| “blob_name” | : “C”, |
| “blob_shape” | : [1], |
| “data_type” | : “INT32” |
| }, | |
| ], | |
| “graph_input_blobs” | : [“X”] |
| “graph_output_blobs” : [“C”] | |
| “node_list” | : [ |
| { | |
| “node_name” | : “add1”, |
| “node_params” | : { |
| “AddKernel” | : { |
| “adder” | : 10 |
| } | |
| }, | |
| “input_blobs” | : [“X”], |
| “output_blobs” | : [“A”], |
| “next_node” | : [“add2”] |
| }, | |
| { | |
| “node_name” | : “add2”, |
| “node_params” | : { |
| “AddKernel” | : { |
| “adder” | : 20 |
| }, | |
| } | |
| “input_blobs” | : [“A”], |
| “output_blobs” | : [“B”], |
| “next_node” | : [“add3”] |
| }, | |
| { | |
| “node_name” | : “add3”, |
| “node_params” | : { |
| “AddKernel” | : { |
| “adder” | : 30 |
| } | |
| }, | |
| “input_blobs” : [“B”], | |
| “output_blobs” : [“C”], | |
| “next_node” | : [ ] |
| }, | |
| ] | |
| } | |

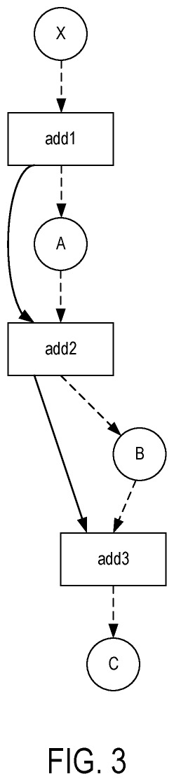

The graph of Example 6 is called “adder3_json” and, for purposes of illustration, is specified as a JSON file. The adder3_json graph defines the various kernels (e.g., nodes) of the graph, a control flow for the kernels of the graph, and a data flow for the kernels of the graph. In Example 6, the control flow of the graph is specified independently (e.g., using separate instructions and/or statements) of the data flow for the graph. Control flow may be implemented as described herein in connection with FIGS. 1, 2, and 3 and defines the order of, or sequence of, execution of the kernels of the graph. FIG. 3 is described in greater detail hereinbelow.

Regarding data flow, the graph is adapted to include name/value pairs that specifically represent buffers. For example, the “blobs” name allows one to define the buffers that are to be used for the graph. The name “blob_name” defines the name of the buffer. The name “blob_shape” defines the shape of the buffer. The name “data_type” defines the particular type of data that is to be stored in the buffer. Accordingly, Example 6 includes buffers X, A, B, and C. The input blob of the graph is specified using the name “graph_input_blobs” as buffer X. The output blob of the graph is specified using the name “graph_output_blobs” as buffer C.

The adder3_json graph of Example 6 also explicitly lists the kernels (e.g., nodes) included therein. The adder3_json graph includes the kernels “add1”, “add2”, and “add3”. Data flow of the adder3_json graph is defined by specifying, for each kernel included therein, the particular input buffer(s) used by that kernel and the particular output buffer(s) used by that kernel (e.g., for each kernel). For example, the add1 kernel has a variety of parameters that are specified. Following the parameters of the kernel, the input buffer(s) and the output buffer(s) of the add1 kernel are explicitly enumerated. In this example, the input buffer of the add1 kernel is specified using the name “input_blobs” and indicates that buffer X is the input buffer of the add1 kernel. The output buffer of the add1 kernel is specified using the name “output_blobs” and indicates that buffer A is the output buffer of the add1 kernel.

Control flow for the adder3_json graph is specified by listing, for each kernel, the next kernel to which the control flows. For example, the next kernel to be invoked following the add1 kernel is specified by the name “next_node” and is add2. The control flow of a graph may specify, for each kernel, a next node to be executed, a plurality of next nodes to be executed in parallel, or that no further node is executed. In this manner, the particular input buffer(s) and output buffer(s) for each kernel may be specified to define the data flow and may be specified independently of the control flow of the graph.

Appreciably, if multiple buffers are used for input and/or output of a given kernel, then such buffers need only be listed for the input_blobs name and/or the output_blobs name for the relevant kernels. For example, if kernel add2 receives two or more inputs, the input buffers need only be specified using the name input_blobs. For example, if kernel add2 receives two buffers X and A, the name/value pair for the input_blobs name would be “input_blobs [“A”, “X” ],”. Similarly, if two or more kernels are to execute in parallel following a particular kernel, then the two or more kernels need only be listed following the next_node name for the kernel. For example, if kernels add2 and add3 are to execute in parallel following add1, then the name/value pair for the next_node name of add1 would be “next_node: [“add2”, “add3” ]”.

FIG. 3 is a visual representation of the graph of Example 6. In the example of FIG. 3, data flow involving buffers X, A, B, and C is illustrated with dashed lines. The buffers X, A, B, and C are illustrated in circular form to differentiate the buffers from the kernels (e.g., nodes), which are shown as rectangles. The control flow of the adder3_json graph is illustrated with solid lines and connects addr1 to addr2 to addr3.

Example 6 and FIG. 3 support a variety of different functionalities that may be implemented by a system as described herein. For example, by specifying buffers for each kernel, in-place operations are supported. One example of the added capability supported by the graph of Example 6 and FIG. 3 is where an input buffer of a selected kernel is updated directly rather than creating a new buffer to receive output from a data transformation. Consider an example where a kernel is to update one or more pixels of a large image such as a Full High-Definition (FHD) image. The graph of Example 6 in which control flow and data flow are specified independently and explicitly allows one kernel to update those pixels directly in an input buffer without having to utilize an additional buffer to output the modified FHD image. Without explicitly specifying data flow within a graph, such operations are not feasible. In graphs where data flow is inferred from the control flow, such an operation would form an impermissible cycle.

Conventional approaches for graphs used with ML applications have specified either control flow or data flow. In cases where the graph specified control flow, the control flow dictated the data flow. In cases where the graph specified data flow, the data flow dictated the control flow. That is, data flow had been inferred from the control flow or control flow had been inferred from data flow. Data flow and control flow were not specified independently of one another in the same graph.

By explicitly defining control flow and data flow separately within a graph, the inventive arrangements allow the graph to not only specify the particular data provided as input and generated as output by kernels, but also to define how that data is conveyed among the nodes and define the order of execution among kernels completely independently of the data flow.

In addition, conventional approaches for graphs used with ML applications often relied on the kernels to opaquely generate output buffers within the kernel code. With the kernels defining/generating buffers, the framework was unaware of whether the buffer used by a first kernel matched the requirements (e.g., was compatible) with the buffer of a second kernel intended to be in communication with the first kernel. In addition, data was necessarily first copied to the host machine before passing that data on to the device buffer of the next kernel in the order of execution.

In accordance with the inventive arrangements described within this disclosure, rather than leaving data handling up to the internal implementation of each respective kernel, a static buffer allocation implemented by the framework (e.g., system manager 102) that supports buffer reuse is utilized. The static buffer implementation described herein, as implemented by the framework, provides the framework with full control over buffer allocation and is facilitated by the explicit data flows specified by the graphs. Buffer allocation and management are described herein below in greater detail.

As described, graphs 106 may be defined in a static format such as JSON. In one or more examples, graphs 106 may be specified in a high-level programming language such as C/C++ that, when executed, invokes functions from an Application Programming Interface (API) provided by the system manager 102 that generate static graphs (e.g., JSON files). By providing graph construction code that may be executed at runtime of the ML application, graphs 106 may be generated dynamically—e.g., on the fly—and then loaded and executed. Dynamic generation of the graphs allows a given ML application to generate a graph “on-the-fly” dynamically during runtime based on real time runtime conditions and/or factors. The ML application may respond to runtime conditions by generating a new graph if the prerequisite condition(s) are detected.

Example 7 below illustrates graph construction code in accordance with one or more examples. The graph construction code of Example 7, upon execution, generates the graph of Example 6. For purposes of illustration, Example 7 is specified in a high-level programming language such as C++.

### Example 7

```
auto create_adder3_graph( ) {
      AKS::Graph g(“adder3”);
      AKS::Blob X{{1}, xir::create_data_type<std::int32_t>( )};
      AKS::Blob A{{1}, xir::create_data_type<std::int32_t>( )};
      AKS::Blob B{{1}, xir::create_data_type<std::int32_t>( )};
      AKS:Blob C{{1}, xir::create_data_type<std::int32_t>( )};
      g.setInputs({X});
      g.setOutputs({C});
      const auto* node1 = g.addNode(“add1”,
      “AddKernel”, create(10), {X}, {A});
      const auto* node2 = g.addNode(“add2”,
      “AddKernel”, create(10), {A}, {B});
      const auto* node3 = g.addNode(“add3”,
      “AddKernel”, create(10), {B}, {C});
      g.addEdge(node2, node3);
      g.addEdge(node1, node2);
      return std::make_pair(stad::move(g), 60);
}
```

The example graph construction code is capable of performing several operations when executed. The graph construction code creates the graph “adder3_json” from Example 6 in memory, creates the data blobs, and sets the input blob(s) and the output blob(s) for the graph and the various kernels. The graph construction code also creates nodes with the provided node names, parent kernel, node parameters (params), input blob(s), output blob(s) as specified. Each unique parent kernel has its own JSON and C++ definition. As noted, each kernel may be specified as a single file. The graph construction code also connects the nodes through edges based on the “addEdge” instruction.

In Example 7, “create” is a utility function that creates the “nodeparams” object required by the addNode function. Example 8 below illustrates an example implementation of the create function.

### Example 8

```
AKS::NodeParams create(int val) {
      AKS::NodeParams res;
      res.setValue(“adder”, val);
      return res;
}
```

The ability of graphs 106 to specify both control flow and data flow provides various benefits. In illustration, in cases where a graph of an ML application supports only the notion of control flow (and not data flow), it is difficult to determine whether a particular node of the graph receives multiple data or whether the node receives single data through multiple conditional data paths. By separating data flow from control flow, the number of input data provided to a node becomes explicitly specified by graphs 106 irrespective of the number conditional paths the node(s) accept.

The ability of graphs 106 to specify both control flow and data flow as described herein, also allows graphs 106 to support conditional execution. In some cases, an ML application may need to skip over one or more nodes of a graph based on the output of a particular node. Example 9 illustrates a case in which the exec_async function of a kernel definition returns an “int” value that can be used to decide or determine the next node to execute. In Example 9, the sample function returns values 0, 1, 2.

### Example 9

```
int ConditionalKernel::exec_asyn (
      std::vector<vart::TensorBuffer *>& in,
      std::vector<vart::TensorBuffer *>& out,
      AKS::NodeParams* params,
      AKS::DynamicParamValues* dynParams)
{
      ConditionalKernel* kbase = this;
      auto [v_input, in_size] = in[0]−>data( );
      int* input=reinterpret_cast<int*>(v_input);
      if(!out.empty( )) {
            auto [v_output, out_size] = out[0]−>data( );
            int* output = reinterpret_cast<int*>(v_output);
            for(int i=0; i<in_size / sizeof(int); ++i) {
                  output[i]=input[i];
            }
      }
      // Comp
      int min_val = params−>getValue<int>(“min”);
      int max_val = params−>getValue<int>(“max”);
      int val = input[0];
      int result;
      if(val < min_val) {
            result = 0;
      } else if(val > max_val) {
            result = 1;
      } else {
            result = 2;
      }
      // std::cout << “Cond: “ << input[0]
      << “ −> “ << result << std::endl;
      Return result;
}
```

Using a kernel as illustrated in Example 9, a graph definition may be specified in which nodes of the graph may be selectively and dynamically connected based on the return value from the source node. Example 10 below illustrates an example graph specified as a graph construction routine in C++.

### Example 10

```
auto create_conditional_graph_v2( ) {
      AKS::Graph g(“conditional”);
      AKS::Blob X, A, B, C, D, E, F;
      g.setInputs({X});
      g.setOutputs({F});
      AKS::NodeParams cond_params {{“min”, 0}, {“max”, 10}};
      const auto* plus2 = g.addNode(“plus2”,
      “Add”, create(2), {X}, {A});
      const auto* sub2 = g.addNode(“sub2”,
      “Add”, create(−2), {X}, {B});
      const auto* plus 10 = g.addNode(“plus10”,
      “Add”, create(10), {A,B}, {C});
      const auto* cond = g.addNode(“cond”,
      “Conditional”, cond_params, {C}, { });
      const auto* add5 = g.addNode(“add5”,
      “Add”, create(5), {C}, {E});
      const auto* sub5 = g.addNode(“sub5”,
      “Add”, create(−5), {C}, {E});
      const auto* add1 = g.addNode(“add1”,
      “Add”, create(1), {E}, {F});
      g.addEdge(plus2, plus10);
      g.addEdge(sub2, plus10);
      g.addEdge(plus10, cond);
      g.addEdge(cond, add5, 0);
      g.addEdge(cond, sub5, 1);
      g.addEdge(add5, add1);
      g.addEdge(sub5, add1);
      return std::make_pair(std::mov(g), 60);
}
```

Example 11 below illustrates a JSON version of the graph.

### Example 11

| { | | |
|---|---|---|
| “graph_name” : “conditional_json”, | | |
| “device_id” : 0, | | |
| “xclbin” : “1x4.xclbin”, | | |
| “blob_list” : [ | | |
| { | | |
| “blob_name” | : “A”, | |
| “blob_shape” | : [1], | |
| “data_type” | : “INT32” | }, |
| { | | |
| “blob_name” | : “B”, | |
| “blob_shape” | : [1], | |
| “data_type” | : “INT32” | }, |
| { | | |
| “blob_name” | : “C”, | |
| “blob_shape” | : [1], | |
| “data_type” | : “INT32” | }, |
| { | | |
| “blob_name” | : “D”, | |
| “blob_shape” | : [1], | |
| “data_type” | : “INT32” | }, |
| { | | |
| “blob_name” | : “E”, | |
| “blob_shape” | : [1], | |
| “data_type” | : “INT32” | }, |
| { | | |
| “blob_name” | : “F”, | |
| “blob_shape” | : [1], | |
| “data_type” | : “INT32” | }, |
| { | | |
| “blob_name” | : “G”, | |
| “blob_shape” | : [1], | |
| “data_type” | : “INT32” | }, |

| ], | |
|---|---|
| “graph_input_blobs” | : [“A”] |
| “graph_output_blobs” : [“G”] | |
| “node_list” : | : [ |
| { | |
| “node_name” | : “plus2”, |
| “node_params” | : { |
| “AddKernel” : { | |
| “adder” | : 2 } |
| }, | |
| “input_blobs” | : [“A”], |
| “output_blobs” | : [“B”], |
| “next_node” | : [“plus 10”] |
| }, | |
| { | |
| “node_name” | : “sub2”, |
| “node_params” | : { |
| “AddKernel” | : { |
| “adder” | : −2 } |
| } | |
| “input_blobs” | : [“A”], |
| “output_blobs” | : [“C”], |
| “next_node” | : [“plus 10”] |
| }, | |
| { | |
| “node_name” | : “plus10”, |
| “node_params” | : { |
| “AddKernel” | : { |
| “adder” | : 10 } |
| }, | |
| “input_blobs“ | : [“B”, C”], |
| “output_blobs” | : [“D”], |
| “next_node” | : [“cond”] |
| }, | |
| { | |
| “node_name” | : “cond”, |
| “node_params” | : { |
| “ConditionalKernel” : { | |
| “min” | : 0, |
| “min” | : 10 } |
| }; | |
| “input_blobs” | : [“D”], |
| “output_blobs” | : [“E”], |
| “next_node” | : { |
| “0” | : [“add5”], |
| “1” | : [“sub5”] |
| } | |
| }, | |
| { | |
| “node_name” | : “add5”, |
| “node_params” | : { |
| “AddKernel” | : { |
| “adder” | : 5 } |
| }, | |
| “input_blobs” | : [“E”], |
| “output_blobs” | : [“F”], |
| “next_node” | : [“add1”] |
| }, | |
| { | |
| “node_name” | : “sub5”, |
| “node_params” | : { |
| “AddKernel” | : { |
| “adder” | : −5 } |
| }, | |
| “input_blobs” | : [“E”], |
| “output_blobs” | : [“F”], |
| “next_node” | : [“add1”] |
| }, | |
| { | |
| “node_name” | : “add1”, |
| “node_params” | : { |
| “AddKernel” | : { |
| “adder” | : 1 } |
| }, | |
| “input_blobs” : [“F”], | |
| “output_blobs” : [“G”] | |
| “next_node” | : [ ] |
| }, | |
| ] | |
| } | |

In example 11, the line “device_id”: 0, specifies an index of the compute circuits to be used for processing. This parameter and value are useful when a given (e.g., single) system has multiple compute circuits. The line “xclbin”: “1x4.xclbin”, specifies a particular overlay that contains hardware logic to be executed on the compute circuits. The overlay (e.g., configuration data) is used to program the compute circuit. As an illustrative and nonlimiting example, for an “Image Resize” operation, there would be an optimized hardware implementation specified by the xclbin parameter. The hardware implementation, e.g., in reference to configuration and/or programming data, may be loaded into the compute circuits and run or executed to perform the resizing operations on an image.

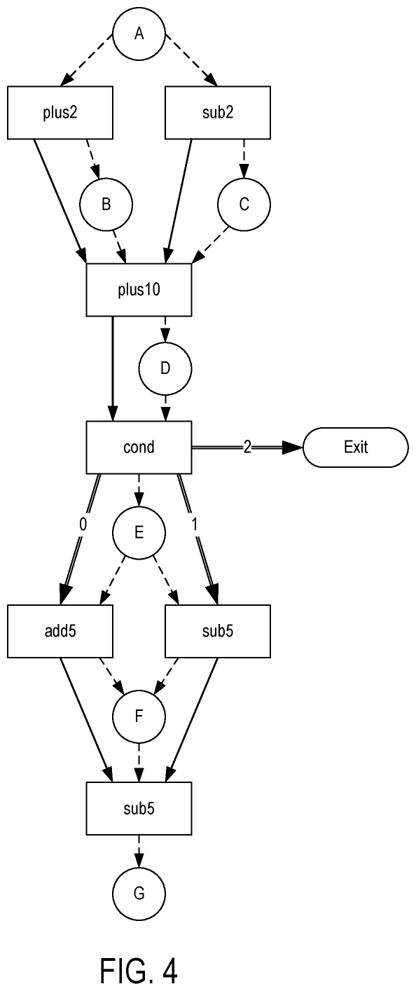

FIG. 4 is a visual representation of the graph of Examples 10 and 11. As may be observed in FIG. 4, which represents the graph of Example 10 and Example 11, conditional paths through the graph are illustrated as compound (e.g., double) solid lines. For example, the conditional paths from the kernel “cond” to the exit condition, to the kernel “add5,” and to the kernel “sub5” are shown. Each of the conditional paths is an alternative path. That is, if one path is taken, the others are not for a given iteration of the graph. Put another way, the kernels “add5” and “sub5” in this example are not executed concurrently. Accordingly, if the output of the “cond” node (as implemented by a kernel) is 0, the conditional path to the “add5” node is taken and the “add5” kernel implementation of the “add5” node is executed. If the output of the cond node is 1, the conditional path to the “sub5” node is taken and the “sub5” kernel implementation of the “sub5” node is executed. If the output of the “cond” node is 2, the conditional path to the “exit” node is taken. By having the cond kernel return a value that may be evaluated by the graph, the graph may branch control to either the add5 kernel, the sub5 kernel, or exit dynamically at runtime depending on the value returned by the cond kernel.

As discussed, the specification of buffers within the graphs by virtue of the blob name/value pairs facilitates static buffer creation and management by the framework as opposed to a dynamic approach where the kernels themselves created buffers at runtime. The buffer management approach described within this disclosure provides several benefits not obtainable with conventional approaches that leave buffer management to kernels. In one aspect, because the framework described herein is aware of the buffers being utilized, the buffers may be re-used during runtime. In another aspect, because buffers may be statically allocated prior to runtime, no latency is incurred due to the creation of buffers at or during runtime. Memory fragmentation due to repeated buffer allocations-deallocations that often slows operation of a system may be avoided.

In one or more example implementations, the framework disclosed herein is capable of querying each kernel to determine the input buffer(s) and output buffer(s) used by that kernel. In addition, the framework is capable of querying each kernel for requirements of the buffer(s). The buffer requirements, referred to herein as buffer metadata, can include, but are not limited to, a size of each buffer, data type for each buffer, a type for each buffer, and/or any other information required to create the buffer(s) for each respective kernel.

As discussed, in some examples, kernels may be implemented in multi-part form with a first component that includes metadata describing various parameters for the kernel and a second component that is executable (e.g., the .so file). The first component may be specified in JSON, for example, and include kernel metadata indicating the type of compute circuit the kernel is intended to operate on and/or buffer metadata for the kernel. In one or more other example implementations, a plurality of kernels may be specified within as single files or within a single file. The file may be specified using a high-level programming language such as C/C++. The file may include both the kernel metadata for each respective kernel and the functional component (e.g., executable code otherwise included in the .so file) for each kernel that executes on a compute circuit. For purposes of illustration, the file may include code as illustrated in both Examples 1 and 3 for each kernel of a given graph. By including multiple kernels and associated kernel metadata in a single file, the administration of multiple kernels and the querying performed for a given graph may be simplified, streamlined, and made more computationally efficient by eliminating the need to access multiple different files for each kernel. For example, the functional program code and the kernel metadata, including buffer metadata, for each kernel of a graph may be included in a single file that may be queried.

The framework described herein is capable of collecting the buffer metadata for each kernel of a given graph and compute a minimal set of buffers to be created for a single job for the graph. The framework does not yet allocate (e.g., create) the buffers. This analysis is done for every graph of the ML application that will be loaded by the framework. For every job enqueued for a particular graph, the framework is capable of creating a Graph Buffer Pool (GBP) based on the buffer metadata as queried.

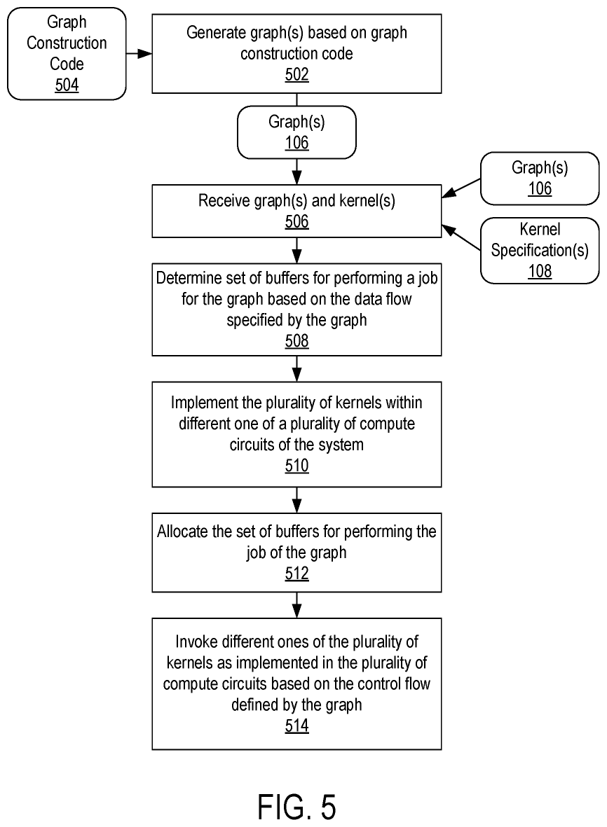

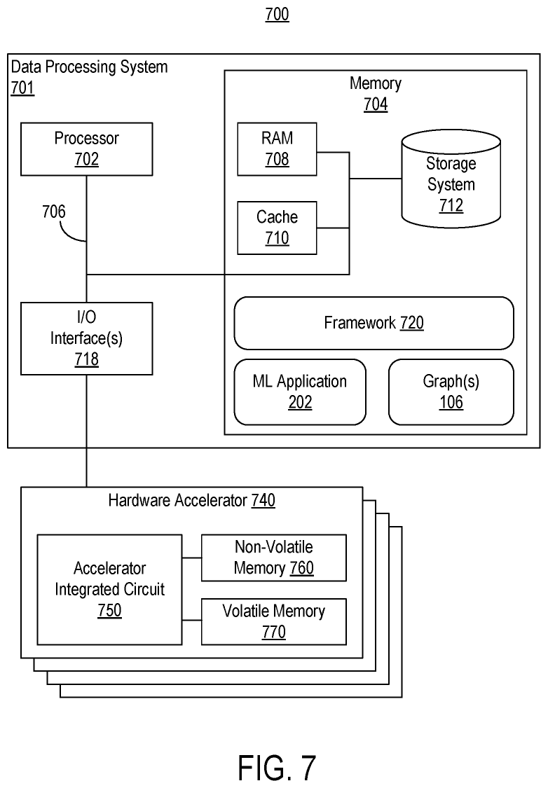

FIG. 5 is a method illustrating certain operative features of the system, e.g., the framework described in connection with FIGS. 1 and 2 as executed by a data processing system having a plurality of compute circuits. As noted, the compute circuits may be heterogeneous compute circuits. For example, the method of FIG. 5 may be implemented by a system as described herein in connection with FIG. 7.

In block 502, the data processing system, e.g., a processor, optionally generates one or more graphs 106 based on corresponding graph construction code 504 that may be received. The graph construction code 504 may be specified as illustrated in connection with Examples 7 or 10, for example. In response to executing graph construction code 504, the data processing system generates one or more of graphs 106. In one or more example implementations, block 502 may be performed at runtime of the ML application to dynamically generate the graph(s) 106.

In block 506, the data processing system receives one or more graphs 106. In one aspect, the data processing system receives graphs as generated in block 502. In another aspect, data processing system receives graphs that may be already formed or implemented. It should be appreciated that in the case where graphs are provided to the data processing system already formed or implemented, block 502 may be omitted. Accordingly, in block 506, the data processing system receives graph 106, whether existing graphs or graphs that were dynamically generated through execution of graph construction code, and kernel specifications 108. As noted, the kernel specifications may be received in any of the different format described herein. Each graph 106 received includes a plurality of nodes corresponding to the plurality of kernels. Examples of graph 106 are illustrated in Examples 6 and 11. Each graph 106 defines a control flow and a data flow for the plurality of kernels.

In block 508, the data processing system determines a set of buffers for performing a job for the graph based, at least in part, on the data flow specified by the graph. As discussed, each graph specifies the data flow by defining one or more input buffers and one or more output buffers for each kernel. The buffers may be statically allocated prior to runtime by the framework executed by the data processing system based on the buffers enumerated using the “blob” name/value pairs in the graph(s).

In one or more examples, the data processing system implements block 508 by querying the buffer metadata specified in the kernel specification file(s). As discussed, the plurality of kernels, and kernel metadata including buffer metadata, are specified in a single file or in a plurality of files. The data processing system is capable of querying the file(s) to determine the buffer requirements for each of the buffers specified by the graph. Prior to runtime, the data processing system determines a set of buffers that are required or necessary to perform one job (e.g., one iteration) of the graph. The set of buffers may be the minimal set of buffers required to perform one job (e.g., iteration) of the graph.

For purposes of illustration, consider a face detection preprocessing kernel as illustrated in Example 12 below. In the example, the kernel specifies buffer metadata for an output buffer. The buffer metadata indicates, by way of the line “auto tensor=xir::Tensor::create(“preproc_out”, {out_height, out_width, 4}, type);”, that the kernel requires one output buffer of char data type and shape=out_height×out_width×4. The buffer metadata also sets other attributes as follows:
Buffer_type: Specifies the Type of this buffer such as host buffer or device buffer.
Device, flags, and memory_group: These parameters may be implementation specific parameters and may be required to allocate a new buffer.
Own_data: Indicates whether the node (e.g., kernel) owns the buffer or not.
Allocatable: Indicates whether this metadata may be used to allocate this buffer. If this parameter is false, the framework will query other kernels to allocate the same buffer.

In determining the buffer requirements by querying the buffer metadata, it should be appreciated that not all attributes are required for all buffers.

### Example 12

std::vector<AKS::BufferMetaData>
FDIPU_AIE_Preproc::get_outputs_metadata
(AKS::NodeParams* params) {
std::vector<AKS::BufferMetaData> res;
int out_height = params−>getValue<int>(“out_height”);
int out_width = params−>getValue<int>(“out_width”);
auto attrs = xir::Attrs::create( );
attrs−>set_attr(“allocatable”, std::make_any<bool>(true));
attrs−>set_attr(“buffer_type”,
std::make_any<AKS::BufferType>(AKS::BufferType::XRT_BO));
attrs−>set_attr(“own_data”, std::make_any<bool>(false));
attrs−>set_attr(“device”, std::make_any<xrt::device*>(device));
attrs−>set_attr(“flags”, std::make_any<xrt::bo::flags>
(xrt::bo::flags::host_only));
attrs−>set_attr(“memory_group”,
std::make_any<xrt::memory_group>(ppkernel _.group_id(4)));
auto type = xir::create_data_type<char>( );
auto tensor = xir::Tensor::create(“preproc_out”,
{ out_height, out_width, 4 }, type);
tensor−>set_attrs(std::move(attrs));
res.push_back(std::move(tensor));
return res;
}

Accordingly, in an aspect, the data processing system, in executing the framework, queries the buffer metadata from the kernel specification to determine, for each kernel of the graph, the input buffer requirements and the output buffer requirements (e.g., buffer size, data type, buffer type, device type for the kernel, and/or any other data required for creating each buffer). The framework collects the buffer requirements and calculates a minimal set of buffers to be created for a single job for the particular graph. The framework does not yet create the buffers. The determination of the set of buffers as described may be performed for every graph to be loaded as part of the ML application. Thus, prior to runtime, the data processing system determines a set of buffers required to perform one job for each graph of the ML application.

The buffers, as defined by the blobs in the graph(s) and within the kernel specification (e.g., the buffer metadata), define how data flows from one kernel to another. Accordingly, as part of block 508, the framework is aware of the particular device in which each kernel executes from the device type of each kernel and may determine buffers for the various kernels in locations (e.g., memories) that are accessible by the respective kernels based on the particular devices in which each respective kernel is to execute and, for example, whether buffer sharing is possible. For example, a producer kernel in a first device with a consumer kernel in a different device are unable to share a buffer for purposes of transferring data. The framework may allocate two buffers (e.g., a first buffer as the output buffer for the producer kernel and a second buffer as the input buffer for the consumer kernel). In another example, by virtue of the graph and kernel specification, the framework may determine that two or more kernels execute in different compute circuits, but are disposed in the same physical device. In that case, in response to making such a determination, the framework may determine that a single buffer may be shared among the two or more kernels for purposes of determining the set of buffers to perform a job of the graph. In the latter example, the device may be a System-on-Chip that includes multiple, different types of compute circuits. The compute circuits, though disposed in a same device, may be heterogeneous or homogeneous compute circuits.

The framework also is capable of supporting so called zero copy capability to facilitate data transfer and/or sharing between kernels executing in the same device. For example, if kernel K1 and kernel K2 are executing in the same device, e.g., an FPGA or an SoC, in response to determining that any of the output of kernel K1 is consumed by kernel K2, the framework is capable of using only one buffer that is shared between kernel K1 and kernel K2. Accordingly, in response to determining that two kernels K1 and K2 are connected in such a way that kernel K1 acts as a producer while kernel K2 acts as a consumer for a particular data, the framework determines that both of the kernels K1 and K2 can share the same buffer rather than creating separate buffers and copying data between the two buffers. In this example, the allocation saves memory resources in the device and further allows the kernels to execute in less time than would be the case than had two buffers been assigned. In the case where two buffers are assigned, such a configuration would require that data from the output buffer of kernel K1 be copied over to the input buffer of kernel K2. This is avoided by the assignment of a single, shared buffer. With the zero copy functionality provided by the framework, the producer kernel writes to a buffer and the consumer kernel reads data directly from that same buffer.

The determination of the set of buffers may include the framework querying each node of the graph for the input and output buffer requirements. The framework is capable of traversing the graph to infer which buffers are shared between different nodes based on the location of each node in terms of compute circuits and/or devices. The framework ensures that for every shared buffer, the requirements from each connected node match in terms of buffer size and device type of the buffer. In response to determining that the buffer requirements match (e.g., the output buffer requirements of the producer node match the input buffer requirements of the consumer node), the framework replaces the buffer requirements of the respective buffers with a single buffer metadata object that is connected to each of the nodes.

In block 510, the data processing system implements the plurality of kernels within different ones of the plurality of compute circuits of the system. As discussed, the compute circuits may be homogeneous or heterogeneous compute circuits (e.g., different types of compute circuits as may be disposed in one or more different physical devices which also may be of different types). For example, the data processing system loads the kernels into the various compute circuits to which each kernel is assigned.

In block 512, the data processing system is capable of allocating the set of buffers for performing the job of the graph. In one aspect, the allocation of the buffers includes creating the buffers in the different memories of the system for use by the respective kernels of the graph.

In block 514, the data processing system invokes different ones of the plurality of kernels as implemented in the plurality of compute circuits based on the order of execution defined by the graph. The data processing system initiates execution of the different kernels as implemented in the compute circuits based on the control flow (e.g., order of execution of the kernels) specified by the graph being executed.

As described, each graph specifies the control flow by specifying a next node to be executed, a plurality of next nodes to be executed in parallel, or that no further node is executed for each kernel. The graph can include logic that, upon execution, selects one of a plurality of conditional branches within the graph based on a value returned by a selected kernel. Each conditional branch, for example, may cause a different kernel to be executed. In that case, the invoking includes selecting one of a plurality of conditional branches within the graph based on the value returned by the selected kernel. Data is passed among the kernels based on the data flow specified. As such, the different ones of the plurality of kernels share data based on the data flow specified by the graph, e.g., the set of buffers as allocated.

During execution of the job for a graph (e.g., invoking the kernels as described in connection with FIG. 5), the framework is capable of automatically transferring and/or sharing data between the different buffers and/or devices. For example, the framework, by virtue of the graph and as part of buffer management, is aware of the particular device in which each kernel of the graph is executing as previously discussed. The framework is capable of internally copying data from one buffer to another other as required before starting the execution of a kernel. For example, consider the case where kernel K1 (a producer kernel) is executing on a first device such as a GPU while the next kernel K2 (a consumer kernel) is executing on a second and different device such as an FPGA device. In that case, prior to starting execution of kernel K2 in the FPGA, the framework copies the output of kernel K1 from the output buffer for kernel K1 for the GPU to the input buffer of kernel K2 for the FPGA.

In one or more examples, more complex scenarios may exist where the output of kernel K1 is to go to multiple other kernels executing on different devices. For example, the output of kernel K1 may need to be provided to kernel K2 executing on an FPGA and also to kernel K3 executing on a CPU and also to kernel K4 executing on a GPU. The framework, being aware of the data flows, is capable of copying the output data from kernel K1 to each of the respective destination kernels prior to initiating execution of each of kernels K2, K3, and K4.

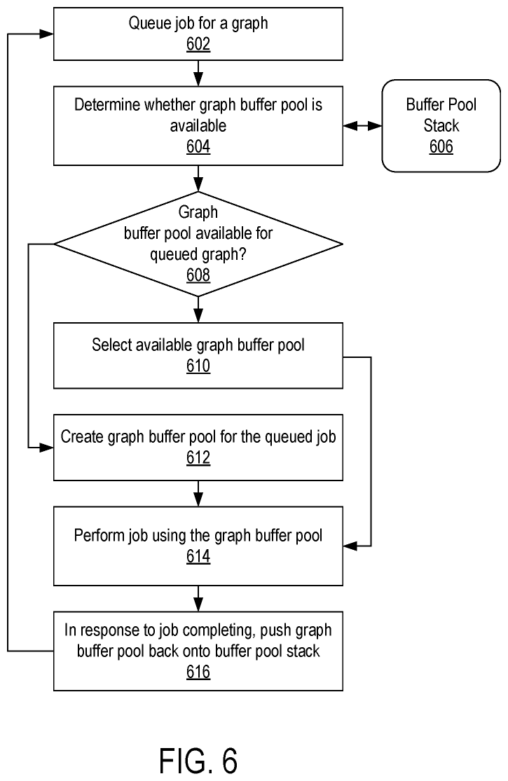

FIG. 6 is a method illustrating certain operative features of the system described in connection with FIGS. 1 and 2 as implemented by a computing environment including a data processing system and a plurality of compute circuits. The compute circuits may be homogeneous or heterogeneous. For example, the method of FIG. 6 may be implemented by a system as described herein in connection with FIG. 7. The method of FIG. 6 may begin in a state where the framework has determined the set of buffers needed to perform a job of a graph. Accordingly, in block 602, a job is queued for the graph.

In block 604, in response to the job being queued, the framework determines whether a graph buffer pool (GBP) is available. A GBP refers to a collection or set of buffers for performing a job of a graph as determined in block 508 of FIG. 5. The system is capable of creating a GBP for each graph. The creation of the GBP allocates or creates the buffers in system memories of the system. The data processing system tracks the available GBPs by maintaining a buffer pool stack (BPS) 606. BPS 606 stores GBPs that are not in use, e.g., GBPs considered to be “available” for jobs of the graph.

Initially, BPS 606 includes no GBPs as the buffers are not created prior to use. As part of block 604, the framework queries BPS 606 to determine whether any GBPs are available. In block 608, in response to determining that BPS 606 includes one or more GBPs, the method proceeds to block 610 where the framework selects an available GBP from BPS 606. In response to determining that BPS 606 includes no GBPs, the method proceeds to block 612 where the framework creates a GBP for the job. The framework generates the GBP based on the set of buffers determined from the buffer metadata previously determined for the graph.

In block 614, the job is performed using the buffers of the GPB. The GBP used may be the GBP obtained from the BPS in block 610 or as generated in block 612. In response to the job completing execution, the GPB is freed and pushed back onto the BPS in block 616. When another job is queued for the graph, the framework obtains the free GBP that is already available in the BPS thereby re-using the already created buffers. The GBP may operate in a last-in-first-out (LIFO) mode. As such, the framework tries to reuse the same GBP for as long as possible thereby providing cache locality benefits. This re-use of buffers through re-use of the GPBs reduces runtime overhead and memory fragmentation.

In response to a new job being enqueued with no free GBPs available inside BPS, the framework is capable of immediately creating a new GBP for the enqueued job. This prevents the pipeline from halting. The GBPs that are created are maintained or stored in BPS 606 when released responsive to a job completing and are available until the ML application ends so that the framework is ready for that many number of outstanding jobs at any point of time. With this structure, the framework need not know the maximum number of outstanding jobs at any point in time.

In accordance with the inventive arrangements described herein, the framework supports automatic buffer allocation and deallocation. For example, the framework is capable of enqueuing multiple jobs asynchronously. This requires multiple buffers (e.g., multiple GBPs) so that each job can be executed in parallel depending upon the hardware capabilities of the system. Since the framework does not know how many outstanding jobs are enqueued at any given time, an approach in which a fixed number of buffers is created upfront may be insufficient or a waste of computing resources.

Other functions such as the ability to pass a buffer handle from one kernel to another also are supported by the framework. For example, as part of executing a graph, a first kernel, as executing, may write data to a device buffer as allocated. The first kernel may pass a handle to the device buffer to a second kernel. The second kernel may access that buffer using the provided buffer handle.

The framework is also capable of supporting non-host buffers. Because the framework is capable of executing ML applications on computing systems with heterogeneous compute circuits, the input data may be received from any device and not necessarily from the host system. The framework may use an abstract interface “vart::TensorBuffer” such that any type of buffer may provide an implementation to this interface and be used with the framework. This functionality allows users to send a buffer from one device type to the framework, which provides the buffer to another kernel presuming the receiving kernel knows how to handle the received data.

FIG. 7 illustrates an example implementation of a system 700 that includes a plurality of compute circuits. The computer circuits may be homogeneous or heterogeneous. In the example, system 700 includes a data processing system 701 and one or more hardware accelerators 740. As defined herein, the term “data processing system” means one or more hardware systems configured to process data, each hardware system including at least one processor and memory, where the processor is programmed with computer-readable instructions that, upon execution, initiate operations. Data processing system is an example of a host system. Data processing system 701 can include a processor 702 (e.g., a host processor), a memory 704, and a bus 706 that couples various system components including memory 704 to processor 702.

Processor 702 may be implemented as one or more processors. In an example, processor 702 is implemented as a central processing unit (CPU). Processor 702 may be implemented as one or more circuits, e.g., hardware, capable of carrying out instructions contained in program code. Processor 702 may be implemented using a complex instruction set computer architecture (CISC), a reduced instruction set computer architecture (RISC), a vector processing architecture, or other known architectures. Example processors include, but are not limited to, processors having an x86 type of architecture (IA-32, IA-64, etc.), Power Architecture, ARM processors, and the like.

Bus 706 represents one or more of any of a variety of communication bus structures. By way of example, and not limitation, bus 706 may be implemented as a Peripheral Component Interconnect Express (PCIe) bus. Data processing system 701 typically includes a variety of computer system readable media. Such media may include computer-readable volatile and non-volatile media and computer-readable removable and non-removable media.

Memory 704 can include computer-readable media in the form of volatile memory, such as random-access memory (RAM) 708 and/or cache memory 710. Data processing system 701 also can include other removable/non-removable, volatile/non-volatile computer storage media. By way of example, storage system 712 can be provided for reading from and writing to a non-removable, non-volatile magnetic and/or solid-state media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 706 by one or more data media interfaces. Memory 704 is an example of at least one computer program product.

Memory 704 is capable of storing computer-readable program instructions that are executable by processor 702. For example, the computer-readable program instructions can include an operating system (not shown), one or more application programs, other program code, and program data. For example, memory 704 may store a framework 720 as described within this disclosure and application 202 (e.g., an ML application) that interacts with framework 720 to execute one or more graphs 106 on different ones of hardware accelerators 740.

Processor 702, in executing the computer-readable program instructions, is capable of performing the various operations described herein that are attributable to a computer. It should be appreciated that data items used, generated, and/or operated upon by data processing system 701 are functional data structures that impart functionality when employed by data processing system 701 and/or accelerator integrated circuits 750 of hardware accelerators 740. As defined within this disclosure, the term “data structure” means a physical implementation of a data model's organization of data within a physical memory. As such, a data structure is formed of specific electrical or magnetic structural elements in a memory. A data structure imposes physical organization on the data stored in the memory as used by an application program executed using a processor.

Data processing system 701 may include one or more Input/Output (I/O) interfaces 718 communicatively linked to bus 706. I/O interface(s) 718 allow data processing system 701 to communicate with one or more external devices and/or communicate over one or more networks such as a local area network (LAN), a wide area network (WAN), and/or a public network (e.g., the Internet). Examples of I/O interfaces 718 may include, but are not limited to, network cards, modems, network adapters, hardware controllers, etc. Examples of external devices also may include devices that allow a user to interact with data processing system 701 (e.g., a display, a keyboard, and/or a pointing device) and/or other devices such as one or more hardware accelerators 740.

Data processing system 701 is only one example implementation. Data processing system 701 can be practiced as a standalone device (e.g., as a user computing device or a server, as a bare metal server), in a cluster (e.g., two or more interconnected computers), or in a distributed cloud computing environment (e.g., as a cloud computing node) where tasks are performed by remote processing devices that are linked through a communications network. In a distributed cloud computing environment, program modules may be located in both local and remote computer system storage media including memory storage devices.

In an example implementation, I/O interface 718 may be implemented as a PCIe interface. Data processing system 701 and hardware accelerators 740 communicate over a communication, e.g., a PCIe communication channel. In one aspect, hardware accelerators 740 may be implemented as circuit boards that couple to data processing system 701 (whether via PCIe or other communication channels). Hardware accelerators 740 may, for example, be inserted into a card slot, e.g., an available bus and/or PCIe slot, of data processing system 701.

Each hardware accelerator 740 may include one or more accelerator integrated circuits (ICs) 750. Hardware accelerator 740 also may include a non-volatile memory 760 and a volatile memory 770, each coupled to accelerator IC 750. Device buffers may be implemented in the volatile memories 770 for the respective accelerator ICs 750. For purposes of illustration, non-volatile memory 760 may be implemented as flash memory while volatile memory 770 may be implemented as a RAM.

Accelerator IC 750 may be implemented as any of a variety of different types of ICs. For example, accelerator IC 750 may be implemented as a System-on-Chip (SoC), an adaptive IC, a Field Programmable Gate Array (FPGA), an Application-Specific IC (ASIC), a Digital Signal Processor (DSP), a Graphics Processing Unit (GPU), a Vision Processing Unit (VPU), or combinations thereof. An adaptive IC is an IC that may be updated subsequent to deployment of the device into the field. The adaptive IC may be optimized, e.g., configured or reconfigured, for performing particular operations after deployment. The optimization may be performed repeatedly over time to meet different requirements or needs. Each accelerator IC 750 may include one compute circuit or a plurality of compute circuits. In some cases, an accelerator IC 750 may include compute circuits of only a same type. In other cases, an accelerator IC 750 may include compute circuits of different types. The inventive arrangements may be used to schedule kernels and allocate buffers for heterogeneous compute circuits disposed in a same accelerator IC and/or in two or more different accelerator ICs (e.g., devices, whether such accelerator ICs are of the same or different types).

The example of FIG. 7 is not intended to suggest any limitation as to the scope of use or functionality of example implementations described herein. System 700 is an example of a computing environment, e.g., computer hardware, having a plurality of heterogeneous compute circuits as implemented in accelerator IC(s) 750, that is capable of performing the various operations described within this disclosure. In this regard, system 700 may include fewer components than shown or additional components not illustrated in FIG. 7 depending upon the particular type of system that is implemented. The particular operating system and/or application(s) included in data processing system 701 may vary according to device and/or system type as may the types of I/O devices included. Further, one or more of the illustrative components may be incorporated into, or otherwise form a portion of, another component. For example, a processor may include at least some memory.

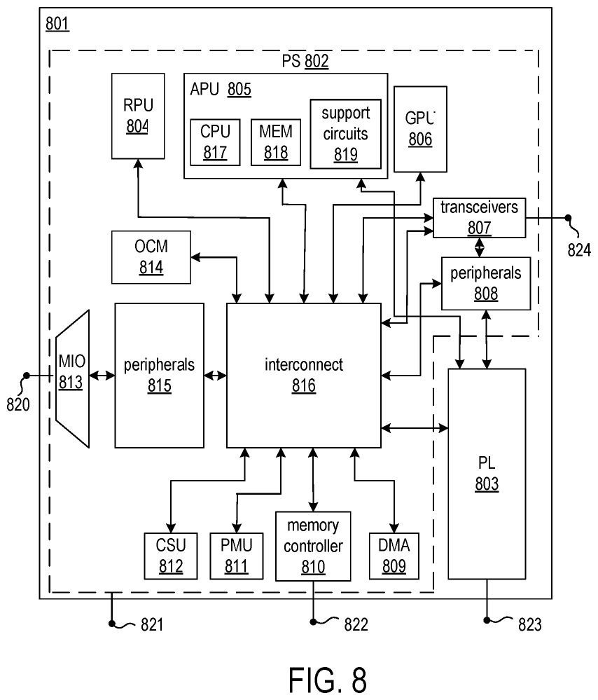

FIG. 8 is a block diagram depicting an example of an example System-on-Chip (SoC) 801. SoC 801 is an example of a programmable IC and is also an example of an accelerator IC 750 that may be used with system 700 of FIG. 7.

In the example, the SoC includes the processor subsystem (PS) 802 and programmable logic (PL) 803. PS 802 includes various processing units, such as a real-time processing unit (RPU) 804, an application processing unit (APU) 805, a graphics processing unit (GPU) 806, a configuration and security unit (CSU) 812, and a platform management unit (PMU) 811. PS 802 also includes various support circuits, such as on-chip memory (OCM) 814, transceivers 807, peripherals 808, interconnect 816, DMA circuit 809, memory controller 810, peripherals 815, and multiplexed (MIO) circuit 813. The processing units and the support circuits are interconnected by interconnect 816. PL 803 is also coupled to interconnect 816. Transceivers 807 are coupled to external pins 824. PL 803 is coupled to external pins 823. Memory controller 810 is coupled to external pins 822. MIO circuit 813 is coupled to external pins 820. The PS 802 is generally coupled to external pins 821. APU 805 can include a CPU 817, memory 818, and support circuits 819. APU 805 can include other circuitry, including L1 and L2 caches and the like. The RPU 804 can include additional circuitry, such as L1 caches and the like. The interconnect 816 can include cache-coherent interconnect or the like.

Referring to the PS 802, each of the processing units includes one or more central processing units (CPUs) and associated circuits, such as memories, interrupt controllers, direct memory access (DMA) controllers, memory management units (MMUs), floating point units (FPUs), and the like. The interconnect 816 includes various switches, busses, communication links, and the like configured to interconnect the processing units, as well as interconnect the other components in the PS 802 to the processing units.

The OCM 814 includes one or more RAM modules, which can be distributed throughout the PS 802. For example, the OCM 814 can include battery backed RAM (BBRAM), tightly coupled memory (TCM), and the like. The memory controller 810 can include a DRAM interface for accessing external DRAM. The peripherals 808, 815 can include one or more components that provide an interface to the PS 802. For example, the peripherals can include a graphics processing unit (GPU), a display interface (e.g., DisplayPort, high-definition multimedia interface (HDMI) port, etc.), universal serial bus (USB) ports, Ethernet ports, universal asynchronous transceiver (UART) ports, serial peripheral interface (SPI) ports, general purpose (GPIO) ports, serial advanced technology attachment (SATA) ports, PCIe ports, and the like. Peripherals 815 can be coupled to MIO circuit 813. Peripherals 808 can be coupled to the transceivers 807. Transceivers 807 can include serializer/deserializer (SERDES) circuits, MGTs, and the like.

The terminology used herein is for the purpose of describing particular embodiments only and is not intended to be limiting. Notwithstanding, several definitions that apply throughout this document are expressly defined as follows.

As defined herein, the singular forms “a,” “an,” and “the” are intended to include the plural forms as well, unless the context clearly indicates otherwise.

As defined herein, the term “approximately” means nearly correct or exact, close in value or amount but not precise. For example, the term “approximately” may mean that the recited characteristic, parameter, or value is within a predetermined amount of the exact characteristic, parameter, or value.

As defined herein, the terms “at least one,” “one or more,” and “and/or,” are open-ended expressions that are both conjunctive and disjunctive in operation unless explicitly stated otherwise. For example, each of the expressions “at least one of A, B, and C,” “at least one of A, B, or C,” “one or more of A, B, and C,” “one or more of A, B, or C,” and “A B, and/or C” means A alone, B alone, C alone, A and B together, A and C together, B and C together, or A, B and C together.

As defined herein, the term “automatically” means without human intervention.

As defined herein, the term “computer-readable storage medium” means a storage medium that contains or stores program instructions for use by or in connection with an instruction execution system, apparatus, or device. As defined herein, a “computer-readable storage medium” is not a transitory, propagating signal per se. The various forms of memory, as described herein, are examples of computer-readable storage media. A non-exhaustive list of examples of computer-readable storage media include an electronic storage device, a magnetic storage device, an optical storage device, an electromagnetic storage device, a semiconductor storage device, or any suitable combination of the foregoing. A non-exhaustive list of more specific examples of a computer-readable storage medium may include: a portable computer diskette, a hard disk, a RAM, a read-only memory (ROM), an erasable programmable read-only memory (EPROM or Flash memory), an electronically erasable programmable read-only memory (EEPROM), a static random-access memory (SRAM), a portable compact disc read-only memory (CD-ROM), a digital versatile disk (DVD), a memory stick, a floppy disk, or the like.

As defined herein, the term “if” means “when” or “upon” or “in response to” or “responsive to,” depending upon the context. Thus, the phrase “if it is determined” or “if [a stated condition or event] is detected” may be construed to mean “upon determining” or “in response to determining” or “upon detecting [the stated condition or event]” or “in response to detecting [the stated condition or event]” or “responsive to detecting [the stated condition or event]” depending on the context.

As defined herein, the term “responsive to” and similar language as described above, e.g., “if,” “when,” or “upon,” means responding or reacting readily to an action or event. The response or reaction is performed automatically. Thus, if a second action is performed “responsive to” a first action, there is a causal relationship between an occurrence of the first action and an occurrence of the second action. The term “responsive to” indicates the causal relationship.

As defined herein, the terms “individual” and “user” each refer to a human being.

As defined herein, the term “hardware processor” means at least one hardware circuit. The hardware circuit may be configured to carry out instructions contained in program code. The hardware circuit may be an integrated circuit. Examples of a hardware processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller.

As defined herein, the terms “one embodiment,” “an embodiment,” “in one or more embodiments,” “in particular embodiments,” or similar language mean that a particular feature, structure, or characteristic described in connection with the embodiment is included in at least one embodiment described within this disclosure. Thus, appearances of the aforementioned phrases and/or similar language throughout this disclosure may, but do not necessarily, all refer to the same embodiment.

As defined herein, the term “output” means storing in physical memory elements, e.g., devices, writing to display or other peripheral output device, sending or transmitting to another system, exporting, or the like.

As defined herein, the term “real-time” means a level of processing responsiveness that a user or system senses as sufficiently immediate for a particular process or determination to be made, or that enables the processor to keep up with some external process.

As defined herein, the term “substantially” means that the recited characteristic, parameter, or value need not be achieved exactly, but that deviations or variations, including for example, tolerances, measurement error, measurement accuracy limitations, and other factors known to those of skill in the art, may occur in amounts that do not preclude the effect the characteristic was intended to provide.

The terms first, second, etc. may be used herein to describe various elements. These elements should not be limited by these terms, as these terms are only used to distinguish one element from another unless stated otherwise or the context clearly indicates otherwise.

A computer program product may include a computer-readable storage medium (or media) having computer-readable program instructions thereon for causing a processor to carry out aspects of the inventive arrangements described herein. Within this disclosure, the term “program code” is used interchangeably with the term “program instructions.” Computer-readable program instructions described herein may be downloaded to respective computing/processing devices from a computer-readable storage medium or to an external computer or external storage device via a network, for example, the Internet, a LAN, a WAN and/or a wireless network. The network may include copper transmission cables, optical transmission fibers, wireless transmission, routers, firewalls, switches, gateway computers and/or edge devices including edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations for the inventive arrangements described herein may be assembler instructions, instruction-set-architecture (ISA) instructions, machine instructions, machine dependent instructions, microcode, firmware instructions, or either source code or object code written in any combination of one or more programming languages, including an object-oriented programming language and/or procedural programming languages. Computer-readable program instructions may include state-setting data. The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or a WAN, or the connection may be made to an external computer (for example, through the Internet using an Internet Service Provider). In some cases, electronic circuitry including, for example, programmable logic circuitry, an FPGA, or a PLA may execute the computer-readable program instructions by utilizing state information of the computer-readable program instructions to personalize the electronic circuitry, in order to perform aspects of the inventive arrangements described herein.

Certain aspects of the inventive arrangements are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, may be implemented by computer-readable program instructions, e.g., program code.

These computer-readable program instructions may be provided to a processor of a computer, special-purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the operations specified in the flowchart and/or block diagram block or blocks.

The computer-readable program instructions may also be loaded onto a computer, other programmable data processing apparatus, or other device to cause a series of operations to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various aspects of the inventive arrangements. In this regard, each block in the flowchart or block diagrams may represent a module, segment, or portion of instructions, which comprises one or more executable instructions for implementing the specified operations.

In some alternative implementations, the operations noted in the blocks may occur out of the order noted in the figures. For example, two blocks shown in succession may be executed substantially concurrently, or the blocks may sometimes be executed in the reverse order, depending upon the functionality involved. In other examples, blocks may be performed generally in increasing numeric order while in still other examples, one or more blocks may be performed in varying order with the results being stored and utilized in subsequent or other blocks that do not immediately follow. It will also be noted that each block of the block diagrams and/or flowchart illustration, and combinations of blocks in the block diagrams and/or flowchart illustration, may be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
receiving, by a hardware processor, a plurality of kernels and a graph including a plurality of nodes corresponding to the plurality of kernels, wherein the graph defines a control flow and a data flow for the plurality of kernels;
implementing, by the hardware processor, the plurality of kernels within different ones of a plurality of compute circuits coupled to the hardware processor;
allocating a set of buffers for performing a job for the graph, wherein the allocating is based, at least in part, on the data flow specified by the graph; and
invoking, by the hardware processor, different ones of the plurality of kernels as implemented in the plurality of compute circuits based on the control flow defined by the graph.

2. The method of claim 1, wherein the different ones of the plurality of kernels share data during execution via the set of buffers as allocated.

3. The method of claim 1, wherein the graph specifies the data flow by defining one or more input buffers and one or more output buffers for each kernel.

4. The method of claim 1, wherein the graph specifies the control flow by, for each kernel, specifying a next node to be executed, a plurality of next nodes to be executed in parallel, or that no further node is executed.

5. The method of claim 1, wherein the plurality of kernels are specified in a file of high-level programming language source code that includes buffer metadata defining requirements of each buffer; and
wherein the set of buffers is determined based on the requirements of each buffer determined by the hardware processor by querying the file including the buffer metadata.

6. The method of claim 1, wherein the allocating further comprises:
at runtime, generating a graph buffer pool that creates the set of buffers for performing the job for the graph; and
maintaining a buffer pool stack for the graph, wherein the buffer pool stack is configured to store graph buffer pools for the graph while not in use.

7. The method of claim 6, wherein, in response to a new job being queued for the graph and no graph buffer pool being available in the buffer pool stack for the graph, creating a new graph buffer pool for the new job for the graph.

8. The method of claim 1, further comprising:
at runtime, executing graph generation program code that is executable to generate the graph at runtime.

9. The method of claim 1, wherein the graph includes logic that, upon execution, selects one of a plurality of conditional branches within the graph based on a value returned by a selected kernel of the plurality of kernels.

10. The method of claim 1, further comprising:
in response to at least two kernels executing in different compute circuits of the plurality of compute circuits disposed in a same device, sharing a single buffer among the at least two kernels.

11. The method of claim 1, wherein the invoking different ones of the plurality of kernels comprises:
writing, by a first kernel, to a device buffer as allocated;
passing, by the first kernel, a handle to the device buffer to a second kernel; and
accessing, by the second kernel, the device buffer.

12. A system, comprising:
one or more hardware processors configured to initiate operations including:
receiving a plurality of kernels and a graph including a plurality of nodes corresponding to the plurality of kernels, wherein the graph defines a control flow and a data flow for the plurality of kernels;
implementing the plurality of kernels within different ones of a plurality of compute circuits coupled to the hardware processor;
allocating a set of buffers for performing a job for the graph, wherein the allocating is based, at least in part, on the data flow specified by the graph; and
invoking different ones of the plurality of kernels as implemented in the plurality of compute circuits based on the control flow defined by the graph.

13. The system of claim 12, wherein the different ones of the plurality of kernels share data during execution via the set of buffers as allocated.

14. The system of claim 12, wherein the graph specifies the data flow by defining one or more input buffers and one or more output buffers for each kernel.

15. The system of claim 12, wherein the graph specifies the control flow by, for each kernel, specifying a next node to be executed, a plurality of next nodes to be executed in parallel, or that no further node is executed.

16. The system of claim 12, wherein the plurality of kernels are specified in a file of high-level programming language source code that includes buffer metadata defining requirements of each buffer; and
wherein the set of buffers is determined based on the requirements of each buffer determined by the hardware processor by querying the file including the buffer metadata.

17. The system of claim 12, wherein the allocating further comprises:
at runtime, generating a graph buffer pool that creates the set of buffers for performing the job for the graph; and
maintaining a buffer pool stack for the graph, wherein the buffer pool stack is configured to store graph buffer pools for the graph while not in use.

18. The system of claim 17, wherein, in response to a new job being queued for the graph and no graph buffer pool being available in the buffer pool stack for the graph, creating a new graph buffer pool for the new job for the graph.

19. The system of claim 12, wherein the one or more hardware processors are configured to initiate operations further comprising:
at runtime, executing graph generation program code that is executable to generate the graph at runtime.

20. The system of claim 12, wherein the graph includes logic that, upon execution, selects one of a plurality of conditional branches within the graph based on a value returned by a selected kernel of the plurality of kernels.
